(19) United States
(12) Patent Application Publication
(10) Pub. No.: US 2026/0170384 A1
(43) Pub. Date: Jun. 18, 2026

(54) APPARATUS, SYSTEM, AND METHOD FOR VERIFYING ENTANGLED STATES IN SUPERCONDUCTING PARAMETRIC AMPLIFIERS

(71) Applicant: The United States of America as represented by the Secretary of the Navy, Arlington, VA (US)

(72) Inventors: Sean Crowe, San Diego, CA (US); Marcio de Andrade

(73) Assignee: The United States of America as represented by the Secretary of the Navy, Arlington, VA (US)

(21) Appl. No.: 18/982,994

(22) Filed: Dec. 16, 2024

(51) Int. Cl. G06N 10/60; G06F 17/18

(52) U.S. Cl. CPC G06N 10/60; G06F 17/18

(57) ABSTRACT

An apparatus, system, and method for verifying entangled states in superconducting parametric amplifiers. In some embodiments, a method for verifying entanglement states of a superconducting parametric amplifier, the steps comprising: receiving a two-mode squeezed state from a superconducting parametric amplifier; performing a state tomography on the two-mode squeezed state, wherein the state tomography yields “N” two-dimensional vectors; estimating a plurality of quantum states with a likelihood function comprising probability distribution of the “N” two-dimensional vectors, wherein the plurality of quantum states are expressed as a linear combination of harmonic oscillator basis functions; determining amplitudes of the plurality of quantum states as a maximum of the likelihood function; and identifying when an entropy measurement for each of the plurality of quantum states is significantly different from zero as an indication that two degrees of freedom are entangled.

### STATEMENT REGARDING FEDERALLY-SPONSORED RESEARCH AND DEVELOPMENT

The United States Government has ownership rights in this invention. Licensing inquiries may be directed to Office of Research and Technical Applications Naval Information Warfare Center Pacific, Code 72120, San Diego, CA, 92152; telephone (619) 553-5118; email: NIWC Pacific T2@us.navy.mil, referencing Navy Case No. 211,172.

### FIELD OF USE

The present disclosure pertains generally to superconducting parametric amplification, including the verification of entangled states at the output of a superconducting parametric amplifier.

### BACKGROUND

In quantum information technology, microwave photon devices are the building blocks of quantum information technology due to the greater stability and control. Nevertheless, detecting photons for microwave signals is a complex task due to the very low energy involved in the process. In order to address this problem, superconducting parametric amplifiers, based on non-dissipative superconducting Josephson junctions, are the ideal elements to control processes involving quantum signals. Specifically, Josephson parametric amplifier (JPA), and later, Josephson Traveling wave parametric amplifiers (JTWPA or TWPA) were invented to amplify signals with a series of Josephson junctions linear placed on a transmission line. JPAs and JTWPAs are capable of producing entangled photon pairs at the microwave regime. Determining the entanglement ate the output of the amplifiers is not an easy task, and commonly involves complex hardware and the addition of other circuit and components operating at ultra-low temperatures.

Accordingly, there is a need for efficiently and accurately assessing the entangled states of superconducting parametric amplifiers.

### SUMMARY

According to illustrative embodiments, a method for verifying entanglement states of a superconducting parametric amplifier, the steps comprising: receiving a two-mode squeezed state from a superconducting parametric amplifier; performing a state tomography on the two-mode squeezed state, wherein the state tomography yields “N” two-dimensional vectors; estimating a plurality of quantum states with a likelihood function comprising probability distribution of said “N” two-dimensional vectors, wherein the plurality of quantum states are expressed as a linear combination of harmonic oscillator basis functions; determining amplitudes of the plurality of quantum states as a maximum of the likelihood function; and identifying when an entropy measurement for each of the plurality of quantum states is significantly different from zero as an indication that two degrees of freedom are entangled.

In some embodiments, an entanglement generation system and quantum data analyzer, comprising: a radiofrequency signal source for providing a signal input, serially connected to a plurality of first attenuators, and serially connected to a first low pass filter; a radiofrequency pump source for providing a pump input, serially connected to a plurality of second attenuators; a directional coupler designed to combine the signal input and the pump input; a superconducting parametric amplifier, serially connected to a circulator and a second low pass filter; a low temperature amplifier configured to receive an output signal from the superconducting parametric amplifier; a room temperature amplifier configured to receive the output signal from the low temperature amplifier; a quantum digital analyzer configured to verify entanglement states of the superconducting parametric amplifier; and a cryogenic cooling system for maintaining an environment comprising the superconducting parametric amplifier at a superconducting temperature.

In some embodiments, a quantum digital analyzer, comprising a processor; a non-transitory storage medium configured to execute computer-readable instructions stored thereon, the instructions comprising: receiving the output signal from the superconducting parametric amplifier; performing a state tomography on the output signal, wherein the state tomography yields “N” two-dimensional vectors; estimating a plurality of quantum states with a likelihood function comprising probability distribution of said “N” two-dimensional vectors, wherein the plurality of quantum states are expressed as a linear combination of harmonic oscillator basis functions; determining amplitudes of the plurality of quantum states as a maximum of the likelihood function; and identifying when an entropy measurement for each of the plurality of quantum states is significantly different from zero as an indication that two degrees of freedom are entangled.

It is an object to provide an apparatus, system, and method for verifying entangled states in superconducting parametric amplifiers that offers numerous benefits, including to provide an analytical method to verify the generation of entangled quantum states at the output of a superconducting parametric amplifier by direct measurement of the amplifier's output in-phase and quadrature voltages representing.

Superconducting parametric amplifiers (SPAs), including Josephson Parametric Amplifiers, Josephson Traveling Wave Parametric Amplifiers, and Traveling Wave Parametric Amplifiers, circuits may generate entangled photons at microwave frequencies. The frequency and bandwidth of these entangled photons depends on characteristics of the device. For example, JTWPAs can be designed with a certain frequency of operation. The frequency selector mechanism of the SPAs allow for producing entangled photons form different frequencies without adding any noise to the system. Knowledge of the existence of an entangled state and the exact microwave characteristics are, therefore, of fundamental importance to practical applications. The apparatus, system, and method described herein will allow a fast way to determine, tune, and select the photon pairs with the desirable frequency that are generated by the SPA. This new apparatus, system, and method enables provides selectivity of entangled photons at frequencies specific to different applications will expedite fabrication techniques and reduce wasted resources and time trying to select a properly working device. An example where such apparatus, system, and method may be of great utility is for utilization in quantum illumination applications, such as non-ionizing instrument for biological imaging. In another possible application, the subject matter of this disclosure may be use as the basis for a Quantum Radar where the photon pairs are required to be split at the source of the SPAs.

It is an object to overcome the limitations of the prior art.

These, as well as other components, steps, features, objects, benefits, and advantages, will now become clear from a review of the following detailed description of illustrative embodiments, the accompanying drawings, and the claims.

### BRIEF DESCRIPTION OF THE DRAWINGS

The accompanying drawings, which are incorporated in and form a part of the specification, illustrate example embodiments and, together with the description, serve to explain the principles of the invention. Throughout the several views, like elements are referenced using like references. The elements in the figures are not drawn to scale and some dimensions are exaggerated for clarity. In the drawings:

FIG. 1 shows an exemplary illustration of an entanglement generation system and quantum data analyzer.

FIG. 2 shows a block-diagram illustration of a method for verifying entanglement states of a superconducting parametric amplifier.

FIG. 3 shows a block-diagram illustration of quantum digital analyzer.

FIG. 4A shows the true probability distribution measurements are drawn from.

FIG. 4B shows an exemplary scatter plot of measurements made from the TMSV distribution.

FIG. 4C shows an exemplary maximum likelihood estimate of the probability distribution.

FIG. 5 shows exemplary ersatz data points on top of the ideal TMSV state.

FIG. 6 shows exemplary ersatz data points on top of the estimated distribution.

FIG. 7 shows a chart of eigenstate probabilities cₘₙ for estimate state.

### DETAILED DESCRIPTION OF EMBODIMENTS

The disclosed apparatus, system, and method below may be described generally, as well as in terms of specific examples and/or specific embodiments. For instances where references are made to detailed examples and/or embodiments, it should be appreciated that any of the underlying principles described are not to be limited to a single embodiment, but may be expanded for use with any of the other apparatuses, systems, and methods described herein as will be understood by one of ordinary skill in the art unless otherwise stated specifically.

References in the present disclosure to “one embodiment,” “an embodiment,” or any variation thereof, means that a particular element, feature, structure, or characteristic described in connection with the embodiments is included in at least one embodiment. The appearances of the phrases “in one embodiment,” “in some embodiments,” and “in other embodiments” in various places in the present disclosure are not necessarily all referring to the same embodiment or the same set of embodiments.

As used herein, the terms “comprises,” “comprising,” “includes,” “including,” “has,” “having,” or any variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or.

Additionally, use of words such as “the,” “a,” or “an” are employed to describe elements and components of the embodiments herein; this is done merely for grammatical reasons and to conform to idiomatic English. This detailed description should be read to include one or at least one, and the singular also includes the plural unless it is clearly indicated otherwise.

Superconducting parametric amplifiers (SPAs) are highly sensitive, low-noise amplifiers that leverage the properties of superconductors and nonlinear elements to amplify weak signals. The key feature of SPAs is their ability to achieve quantum-limited noise performance, which makes them important in fields where signal fidelity is critical, including quantum computing, radio astronomy, and low-noise communications. Types of SPAs include Josephson parametric amplifiers (JPAs), Josephson traveling-wave parametric amplifiers (JTWPAs), and Traveling-wave parametric amplifiers (TWPAs). SPAs are especially useful in the microwave frequency range, where other types of amplifiers struggle maintain high sensitivity and low noise.

Core components of SPAs commonly include Josephson junctions, nonlinear transmission lines, and superconducting resonators. Josephson junction offer key benefits that enable the nonlinearity required for the parametric process. To operate, SPAs are pumped with a microwave signal that interacts with an input signal, and may be designed to for phase-sensitive amplification or phase-preserving amplification. Some SPA, such as JTWPAs, may employ arrays of Josephson junctions along a transmission line to achieve broadband amplification by managing dispersion and phase matching. SPAs typically output a squeezed state of the microwave field, which is a quantum state with reduced fluctuations in one quadrature at the expense of increased fluctuations in the other quadrature. In some cases, squeezed state may be a squeezed state with reduced fluctuations in one quadrature. In other cases, the squeezed state may be a two-mode squeezed state where there is a quantum sate that exhibits squeezing in two entangled modes of the electromagnetic field.

Measurement and verification of entangled states is essential to the operation of SPAs and is currently achieved with resource-intensive and time-consuming efforts. Existing techniques are only applicable to non-Gaussian states, also known as non-classical states, which characterize the correlations and non-classical properties of the generated state. Existing methods are experimental methods that are cumbersome and lengthy. For example, some existing methods needed to calibrate amplifiers perform a shot noise tunnel junction (SNTJ). When utilizing a SNTJ it is necessary to fabricate an additional circuitry, adding long lengths of time to manually insert additional circuitry into the process. Another existing method involves using a diplexer. Once again, the addition of a component involves extra cryogenic wiring and set-up. Moreover, all existing methods, including the ones mention, also require work to process and analyze the output data.

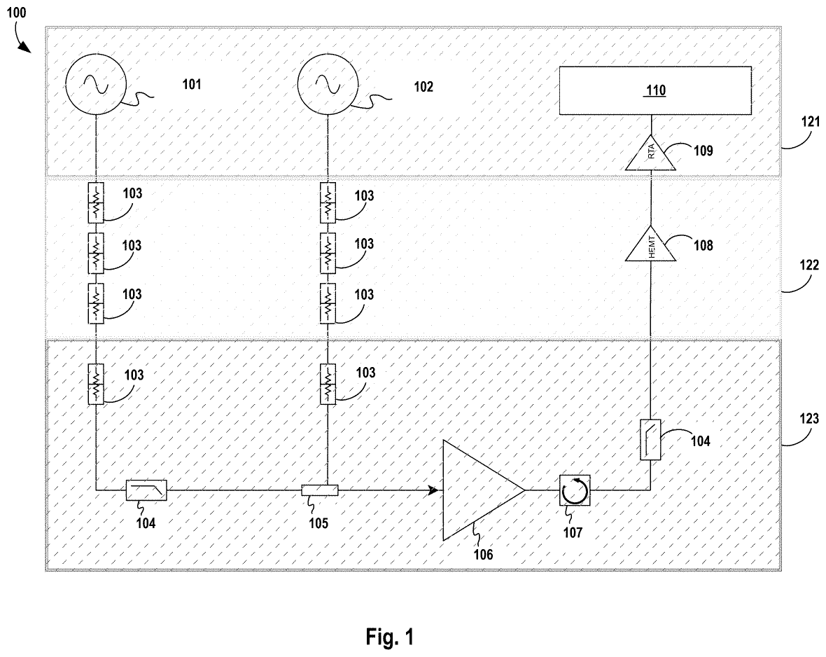

FIG. 1 shows an exemplary illustration of a entanglement generation system and quantum data analyzer comprising an radiofrequency (RF) signal source 101, a RF pump source 102, a plurality of attenuators 103, a plurality of low pass filters 104, a directional coupler 105, a superconducting parametric amplifier 106, a circulator 107, a low temperature amplifier 108, a room temperature amplifier 109, and a quantum digital analyzer 110. Each of the plurality of components are electrically connected, as shown in the electrical diagram illustration of FIG. 1. Additionally, some of the listed components must be kept ultra-low, superconducting temperatures. These temperatures may be achieved by cryogenic cooling systems including, but not limited to, dilution refrigerators, helium-based cryostats, adiabatic demagnetization refrigerators, closed-cycle cryocoolers, and multi-stage cooling systems. The top section 121 of FIG. 1 highlights the components that may be used in a room temperature environment. The middle section 122 highlights the components as those that may operate in an environment between room temperature at superconducting temperatures. For example, the bottom section 123 may be maintained at around 10 millikelvin (mKT) to properly function, which comprising at least two attenuators 103, at least two low pass filters 104, a directional coupler 105, a superconducting parametric amplifier 106, and a circulator 107. Whereas, other components need not be maintained at superconducting temperatures and may be situated in environments with temperatures between around 10 mKT and room temperature (RT), such as a plurality of attenuators 103 and the low temperature amplifier 108. Finally, the RF signal source 101, the RF pump source 102, the room temperature amplifier 109, and quantum digital analyzer 110, may be in an environment that is room temperature.

In some embodiments, an entanglement generation system 100 and quantum data analyzer 110 comprises a radiofrequency signal source 101 for providing a signal input, serially connected to a plurality of first attenuators 103, and serially connected to a first low pass filter 104; a radiofrequency pump source for providing a pump input 102, serially connected to a plurality of second attenuators 103; a directional coupler 105 designed to combine the signal input and the pump input; a superconducting parametric amplifier 106, serially connected to a circulator 107 and a second low pass filter 104; a low temperature amplifier 108 configured to receive an output signal from the superconducting parametric amplifier 106; a room temperature amplifier 109 configured to receive the output signal from the low temperature amplifier 108; a quantum digital analyzer 110 configured to verify entanglement states of the superconducting parametric amplifier; and a cryogenic cooling system for maintaining an environment comprising the superconducting parametric amplifier at a superconducting temperature. A serial connection may be an electrical connection of circuitry components arranged in a series.

Furthermore, a quantum digital analyzer 300 further may further comprise a processor 303; a non-transitory storage medium 301 configured to execute computer-readable instructions stored thereon, the instructions comprising: receiving the output signal from the superconducting parametric amplifier; performing a state tomography on the output signal, wherein the state tomography yields “N” two-dimensional vectors; estimating a plurality of quantum states with a likelihood function comprising probability distribution of said “N” two-dimensional vectors, wherein the plurality of quantum states are expressed as a linear combination of harmonic oscillator basis functions; determining amplitudes of the plurality of quantum states as a maximum of the likelihood function; and identifying when an entropy measurement for each of the plurality of quantum states is significantly different from zero as an indication that two degrees of freedom are entangled.

The entanglement generation system and quantum data analyzer may be used in any environment in which proper temperature may be maintained and verification of entanglement states is desired. Such circumstances may include laboratory conditions in which quantum system need to be calibrated and verified before use, such as in initial setup. Additionally, circumstances further include field use in which the reverification of entanglement of quantum states is desired. In particular the quantum digital analyzer enabled the method for verifying entanglement states of a superconducting parametric amplifier may be used in any environment which verification is desired, and may be remote from the entanglement generation system, in some embodiments. Further, the entanglement generation system and quantum data analyzer may be used in combination with control circuits in various quantum applications. For example, the entanglement generation system and quantum data analyzer may be used to verify systems involving Qbits, quantum illumination, and quantum radar, etc.

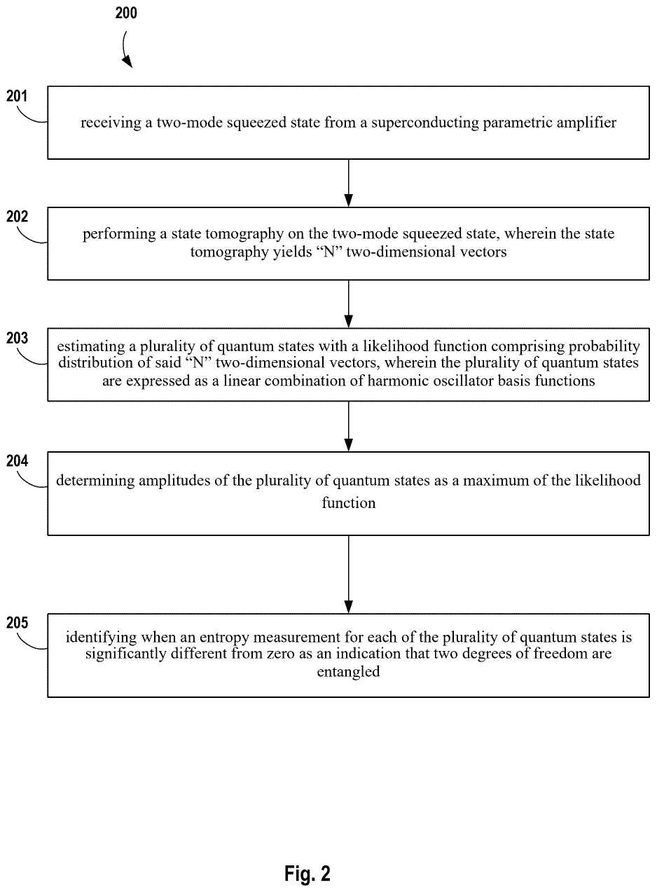

FIG. 2 shows a block-diagram illustration of a method 200 for verifying entanglement states of a superconducting parametric amplifier, the steps comprising receiving a two-mode squeezed state from a superconducting parametric amplifier 201; performing a state tomography on the two-mode squeezed state, wherein the state tomography yields “N” two-dimensional vectors 202; estimating a plurality of quantum states with a likelihood function comprising probability distribution of said “N” two-dimensional vectors, wherein the plurality of quantum states are expressed as a linear combination of harmonic oscillator basis functions 203; determining amplitudes of the plurality of quantum states as a maximum of the likelihood function 204; and identifying when an entropy measurement for each of the plurality of quantum states is significantly different from zero as an indication that two degrees of freedom are entangled 205.

The step of receiving a two-mode squeezed state from a superconducting parametric amplifier 201 comprises receiving an output of one a superconducting parametric amplifiers. The plurality of superconducting parametric amplifiers may include independent and identically prepared two-dimensional systems including, but not limited to SPAs, JPAs, JTWPAs, and TWPAs. Furthermore, the output may be a two-mode squeeze state that is measureable by a state tomography technique.

The step of performing a state tomography on the two-mode squeezed state, wherein the state tomography yields “N” two-dimensional vectors 202 may comprise a resulting data set, {x\vec{ }₁, . . . , x\vec{ }_{N}}, where x\vec{ }ᵢ is a two-dimensional vector corresponding to the ith measurement.

The step of estimating a plurality of quantum states with a likelihood function comprising probability distribution of said “N” two-dimensional vectors, wherein the plurality of quantum states are expressed as a linear combination of harmonic oscillator basis functions 203, may comprising the likelihood function:

$$L ( {c}_{m n} ) = {\prod }_{i = 1}^{N} P ( {\vec{x}}_{i} \vert {c}_{m n} ) . \qquad ( eq . 1 )$$

In the likelihood function (eq. 1), P estimates the probability distribution of the measurement set {x\vec{ }₁, . . . , x\vec{ }_{N}}. Furthermore, P is parametrized by the coefficients cₘₙ. This likelihood function is maximized when P is as close as possible to the true distribution. In one embodiment, the maximum likelihood estimate for the coefficients cₘₙ may be found by solving the system of equations:

$$\frac{\partial L}{\partial {c}_{m n}} = 0 .$$

In another embodiment, a maximum likelihood estimated by maximizing the log-likelihood function, which may be beneficial because the product becomes a sum and numerical round off errors may be avoided. Quantum theory provides a definite formula for computing these probabilities, in particular, P(\vec{x}ᵢ|cₘₙ)=( [symbol] \vec{x}ᵢ|Ψ(cₘₙ) [symbol] |²d²\vec{x}. Accordingly, one may express the maximum likelihood estimation as a linear combination of harmonic oscillator basis functions:

$$\vert Ψ 〉 = {\sum }_{m , n = 0}^{M} {c}_{m n} \vert mn 〉 . \qquad ( eq . 2 )$$

Eq. 2 represents a quantum state |Ψ [symbol] in a two-dimensional Hilbert space comprising a summation over two indices, m and n, ranging from 0 to M. The coefficients cₘₙ are complex or real numbers that serve as coefficients for each basis state |mn [symbol] . In one embodiment, the method 200 for verifying entanglement states of a superconducting parametric amplifier may comprising truncating the sum at M basis functions for eventual numerical analysis. Finally, the maximum likelihood estimation comprises an uncertainty value, which is useful later in the analysis. The uncertainty value correlates with a significant deviation in entropy.

The step of determining amplitudes of the plurality of quantum states as a maximum of the likelihood function 204 comprises calculated amplitudes (cₘₙ from eq. 2) that multiplies each state in the superposition. In the harmonic oscillator basis function, the amplitude refers to the magnitude of the wave function at a given position. The amplitudes of the linear combination of harmonic oscillator functions may be estimated from the maximum likelihood calculation. Provided the amplitudes, one may then calculate the entanglement entropy of each of the plurality of quantum states.

The step of identifying when an entropy measurement for each of the plurality of quantum states is significantly different from zero as an indication that two degrees of freedom are entangled 205 may further comprise calculating entanglement entropy for each of the plurality of quantum states. In one embodiment, one may calculate entropy by the equation:

$$S = - {\sum }_{m , n}^{M} {\vert {c}_{m n} \vert}^{2} log {\vert {c}_{m n} \vert}^{2} . \qquad ( eq . 3 )$$

Eq. 3 describes quantum entropy for the quantum system as a sum that runs over all possible pairs of m and n. While cₘₙ is the amplitude for the entangled states, |cₘₙ|² is the probability that the system is found in the state |mn [symbol] . The Shannon entropy equation, or von Neumann entropy for a pure quantum state, may then be used to quantify the entanglement entropy of the plurality of quantum states based on the distribution of the amplitude cₘₙ coefficients. Entropy S provides a measure of the spread of the plurality of quantum states. When the entropy is significantly different from zero, it is an indication that the two degrees of freedom are entangled. A significant difference from zero may be determined from the uncertainty value provided in the maximum likelihood estimation. If the value of a different is beyond that of an uncertainty threshold, it may be realized as an indication that the two degrees of freedom are entangled.

Quantifying the uncertainty in a maximum likelihood estimation may be accomplished by calculating confidence intervals. For example, the confidence interval for parameter \vec{x}ᵢ may be

$$= {\vec{x}}_{i} \pm {z}_{α / 2} \sqrt{Var ( {\vec{x}}_{i} )} ,$$

where z_{α/2} is a critical value of the standard normal distribution. As another example,

$$CI = {\vec{x}}_{i} \pm z \frac{s}{\sqrt{n}}$$

also be used to calculate a confidence interval, where z is the confidence level value, s is a sample standard deviation, and n is the sample size.

Once the entanglement estimation is identified, the subject superconducting parametric amplifier is verified. Accordingly, the verified source of entangled states may then be used for other applications.

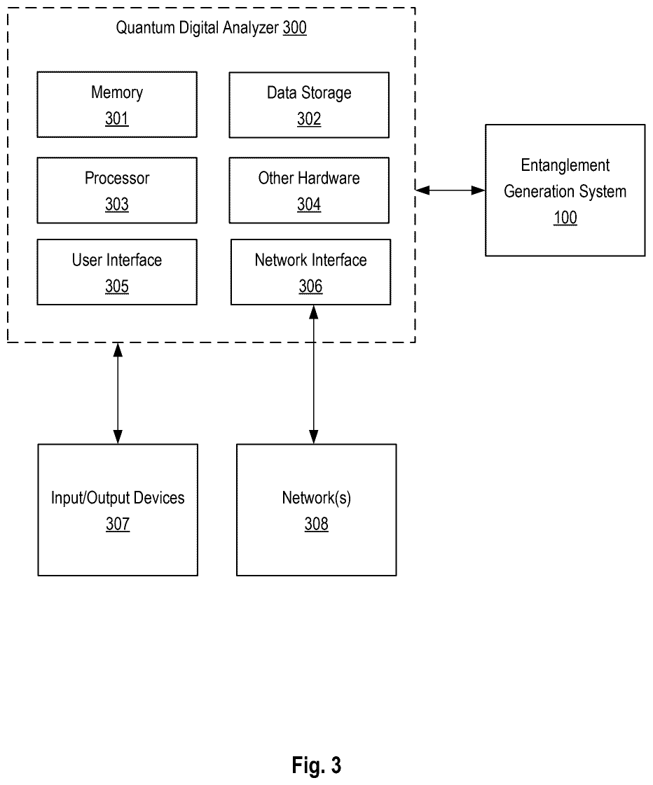

FIG. 3 shows a block-diagram illustration of quantum digital analyzer 300 comprising memory 301, data storage 302, at least one processor 303, other hardware 304, a user interface 305, network interface 306, and may be connected through wired or wireless mediums to input/output devices 307, network(s) 308, and an entanglement generation system 100.

A quantum digital analyzer 300 typically includes a computing device comprising variety of non-transitory computer readable media. By way of example, and not limitation, computer readable media may comprise Random Access Memory (RAM); Read Only Memory (ROM); Electronically Erasable Programmable Read Only Memory (EEPROM); flash memory or other memory technologies; CDROM, digital versatile disks (DVDs) or other optical or holographic media; magnetic cassettes, magnetic tape, magnetic disk storage or other magnetic storage devices, or any other medium that can be used to encode desired information and be accessed by quantum digital analyzer 300. Computer storage media does not, however, include propagated signals. Rather, computer storage media excludes propagated signals. Any such computer storage media may be part of quantum digital analyzer 300.

Memory 301 includes computer storage media in the form of volatile and/or nonvolatile memory. The memory may be removable, non-removable, or a combination thereof. Examples of hardware devices include solid-state memory, hard drives, optical-disc drives, etc. Processors 163 read data from various entities such as memory 301 or I/O components 307. Memory 301 stores, among other data, one or more applications. The applications, when executed by the one or more processors, operate to perform functionality on the computing device. The applications may communicate with counterpart applications or services such as web services accessible via a network (not shown). For example, the applications may represent downloaded client-side applications that correspond to server-side services executing in a cloud. In some examples, aspects of the disclosure may distribute an application across a computing system, with server-side services executing in a cloud based on input and/or interaction received at client-side instances of the application. In other examples, application instances may be configured to communicate with data sources and other computing resources in a cloud during runtime, such as communicating with a cluster manager or health manager during a monitored upgrade or may share and/or aggregate data between client-side services and cloud services.

Inventors performed a numerical experiment to verify this formalism. The experiment described below merely illustrates a successful demonstration of this subject matter, and is not so limiting. Inventors prepared a two-mode squeezed vacuum state (TMSV) with squeezing parameters r=1 and φ=0. Inventors drew 100 data points from this ideal probability distribution. Using the maximum likelihood analysis described above, Inventors then fit a quantum state with 25 basis function to this ersatz data. Ersatz data refers to artificial or synthetic data that is generated to mimic or replace real-world data.

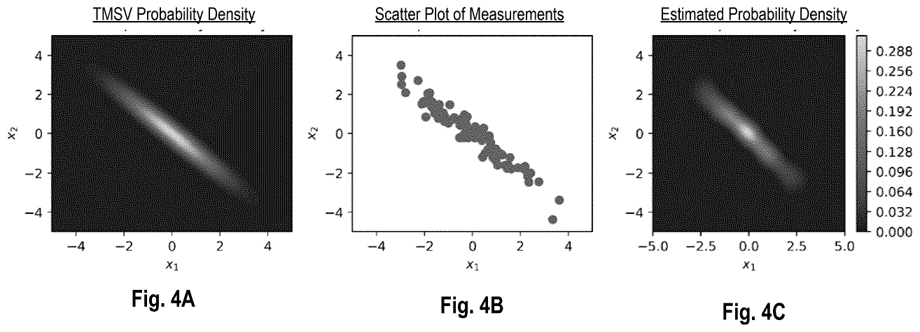

FIGS. 4A, 4B, and 4C shows three graphs comprising an ideal distribution, measured data, and an estimated state. FIG. 4A shows the true probability distribution measurements are drawn from. FIG. 4B shows an exemplary scatter plot of measurements made from the TMSV distribution. FIG. 4C shows an exemplary maximum likelihood estimate of the probability distribution. FIGS. 4A-4C demonstrate qualitative agreement between the ideal and estimated states. Small differences are expected due to shot noise and truncation of the Hilbert space. Using the estimated amplitudes, inventors computed the entanglement entropy and found S_{est.}=1.633. The value of the entanglement entropy for the ideal TMSV can be computed from the r parameter, and we find that it is equal to S_{exact}=1.619. Inventors' estimate of the entanglement entropy is therefore close to the exact value despite a small sample size and a small number of basis functions.

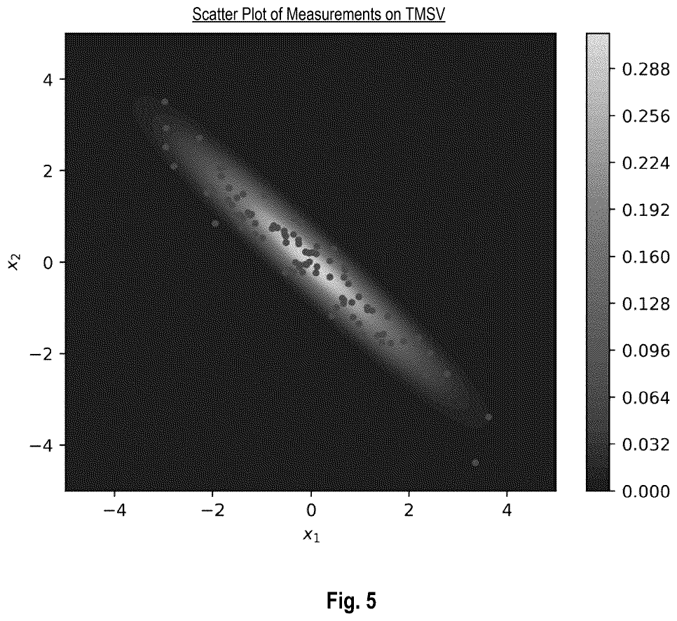

FIG. 5 shows exemplary Ersatz data points on top of the ideal TMSV state. As shown in FIG. 5, the ideal TMSZ closely correlates with the Ersatz data points. This is expected for the ideal TMSV state.

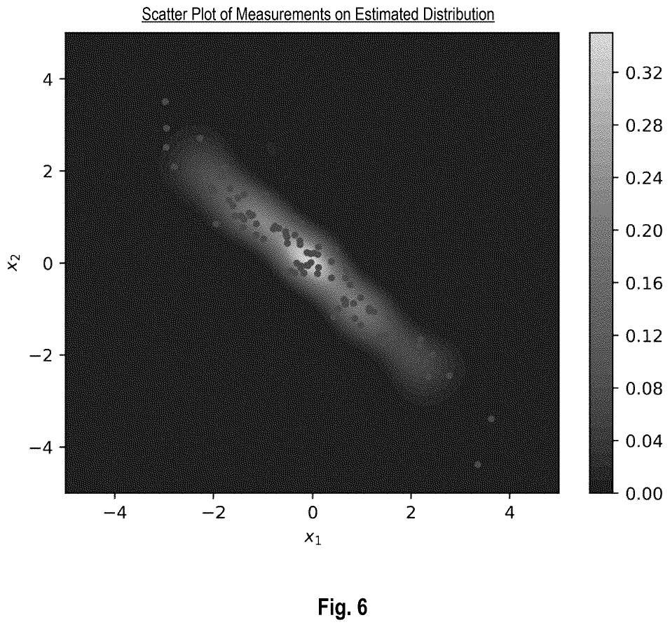

FIG. 6 shows exemplary Ersatz data points on top of the estimated distribution. As shown in FIG. 6, the estimated values also correlate closely with the ideal TMSV distribution. As similarly described above, inventors computed the entanglement entropy and found S_{est.}=1.633 compared to the S_{exact}=1.619, in an example embodiment. Accordingly, the estimates are accurate to the ideal TMSV state.

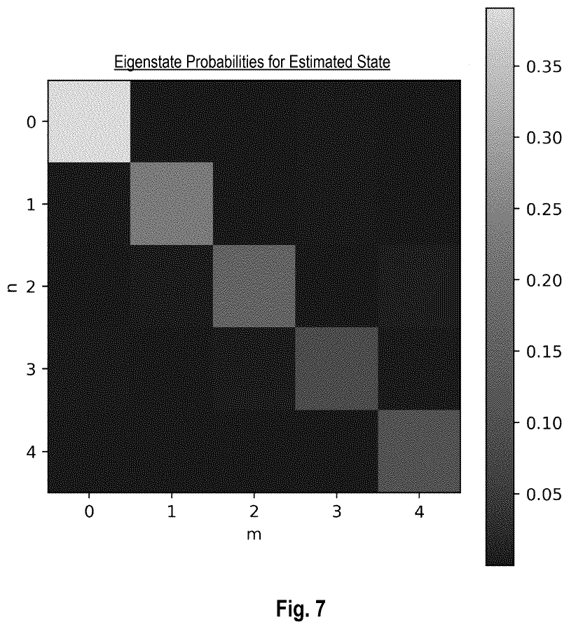

FIG. 7 shows a chart of Eigenstate Probabilities cₘₙ for Estimate State. Consistent with a TMSV, here one should notice most of the state is concentrated along the diagonal and decreases as m and n increase. This consistency reinforces confidence of an accurate estimate of entangled states.

From the above description of Apparatus, System, and Method for Verifying Entangled States in Superconducting Parametric Amplifiers, it is manifest that various techniques may be used for implementing the concepts of method for verifying entanglement states of a superconducting parametric amplifier, and an entanglement generation system and quantum data analyzer without departing from the scope of the claims. The described embodiments are to be considered in all respects as illustrative and not restrictive. The method/apparatus disclosed herein may be practiced in the absence of any element that is not specifically claimed and/or disclosed herein. It should also be understood that method for verifying entanglement states of a superconducting parametric amplifier, and an entanglement generation system and quantum data analyzer are not limited to the particular embodiments described herein, but is capable of many embodiments without departing from the scope of the claims.

What is claimed:

1. A method for verifying entanglement states of a superconducting parametric amplifier, the steps comprising:
receiving a two-mode squeezed state from a superconducting parametric amplifier;
performing a state tomography on the two-mode squeezed state, wherein the state tomography yields “N” two-dimensional vectors;
estimating a plurality of quantum states with a likelihood function comprising probability distribution of said “N” two-dimensional vectors, wherein the plurality of quantum states are expressed as a linear combination of harmonic oscillator basis functions;
determining amplitudes of the plurality of quantum states as a maximum of the likelihood function; and
identifying when an entropy measurement for each of the plurality of quantum states is significantly different from zero as an indication that two degrees of freedom are entangled.

2. The method for verifying entanglement states of a superconducting parametric amplifier of claim 1, wherein the superconducting parametric amplifier is a Josephson parametric amplifier.

3. The method for verifying entanglement states of a superconducting parametric amplifier of claim 1, wherein the superconducting parametric amplifier is a Josephson traveling wave parametric amplifier.

4. The method for verifying entanglement states of a superconducting parametric amplifier of claim 1, wherein said amplitudes are determined by maximizing a log-likelihood function.

5. The method for verifying entanglement states of a superconducting parametric amplifier of claim 1, wherein significantly different is determined by an uncertainty value calculated from the maximum likelihood estimation.

6. An entanglement generation system and quantum data analyzer, comprising:
a radiofrequency signal source for providing a signal input, serially connected to a plurality of first attenuators, and serially connected to a first low pass filter;
a radiofrequency pump source for providing a pump input, serially connected to a plurality of second attenuators;
a directional coupler designed to combine the signal input and the pump input;
a superconducting parametric amplifier, serially connected to a circulator and a second low pass filter;
a low temperature amplifier configured to receive an output signal from the superconducting parametric amplifier;
a room temperature amplifier configured to receive the output signal from the low temperature amplifier;
a quantum digital analyzer configured to verify entanglement states of the superconducting parametric amplifier; and
a cryogenic cooling system for maintaining an environment comprising the superconducting parametric amplifier at a superconducting temperature.

7. The entanglement generation system and quantum data analyzer of claim 5, wherein the quantum digital analyzer further comprises:
a processor;
a non-transitory storage medium configured to execute computer-readable instructions stored thereon, the instructions comprising:
receiving the output signal from the superconducting parametric amplifier;
performing a state tomography on the output signal, wherein the state tomography yields “N” two-dimensional vectors;
estimating a plurality of quantum states with a likelihood function comprising probability distribution of said “N” two-dimensional vectors, wherein the plurality of quantum states are expressed as a linear combination of harmonic oscillator basis functions;
determining amplitudes of the plurality of quantum states as a maximum of the likelihood function; and
identifying when an entropy measurement for each of the plurality of quantum states is significantly different from zero as an indication that two degrees of freedom are entangled.

8. The entanglement generation system and quantum data analyzer of claim 7, wherein said amplitudes are determined by maximizing a log-likelihood function.

9. The entanglement generation system and quantum data analyzer of claim 7, wherein significantly different is determined by an uncertainty value calculated from the maximum likelihood estimation.

10. The entanglement generation system and quantum data analyzer of claim 6, wherein the output signal is a two-mode squeezed state.

11. The entanglement generation system and quantum data analyzer of claim 6, wherein the superconducting parametric amplifier is a Josephson parametric amplifier.

12. The entanglement generation system and quantum data analyzer of claim 6, wherein the superconducting parametric amplifier is a Josephson traveling wave parametric amplifier.

13. A quantum digital analyzer, comprising:
a processor;
a non-transitory storage medium configured to execute computer-readable instructions stored thereon, the instructions comprising:
receiving the output signal from the superconducting parametric amplifier;
performing a state tomography on the output signal, wherein the state tomography yields “N” two-dimensional vectors;
estimating a plurality of quantum states with a likelihood function comprising probability distribution of said “N” two-dimensional vectors, wherein the plurality of quantum states are expressed as a linear combination of harmonic oscillator basis functions;
determining amplitudes of the plurality of quantum states as a maximum of the likelihood function; and
identifying when an entropy measurement for each of the plurality of quantum states is significantly different from zero as an indication that two degrees of freedom are entangled.

14. The quantum digital analyzer of claim 13, wherein the superconducting parametric amplifier is a Josephson parametric amplifier.

15. The quantum digital analyzer of claim 13, wherein the superconducting parametric amplifier is a Josephson traveling wave parametric amplifier.

16. The quantum digital analyzer of claim 13, wherein said amplitudes are determined by maximizing a log-likelihood function.

17. The quantum digital analyzer of claim 13, wherein significantly different is determined by an uncertainty value calculated from the maximum likelihood estimation.
